(19) United States
(12) Patent Application Publication
(10) Pub. No.: US 2026/0279378 A1
(43) Pub. Date: Sep. 17, 2026

(54) METHOD FOR SEPARATING FAR-FIELD AND NEAR-FIELD VOICE, APPARATUS AND WEARABLE DEVICE

(71) Applicant: AAC Acoustic Technologies (Shanghai) Co., Ltd., Shanghai (CN)

(72) Inventors: Lianwu Chen, Shanghai (CN); Xuejing Sun, L.A., CA (US)

(21) Appl. No.: 19/342,720

(22) Filed: Sep. 29, 2025

Related U.S. Application Data
(63) Continuation of application No. PCT/CN2025/082499, filed on Mar. 14, 2025.

(51) Int. Cl. G10L 21/0308; G10L 21/0208; G10L 21/0216; G10L 21/0232; G10L 25/30

(52) U.S. Cl. CPC G10L 21/0308; G10L 21/0216; G10L 21/0232; G10L 25/30; G10L 2021/02087; G10L 2021/02166

(57) ABSTRACT

The present application provides a method for separating a far-field and near-field voice and apparatus and a wearable device. The method includes: obtaining a near-field beamforming signal and a far-field beamforming signal according to microphone array signal obtained in a target scenario and a beamforming algorithm; calculating distinguishing features between the near-field beamforming signal and the far-field beamforming signal; obtaining a near-field voice probability of the microphone array signal according to the distinguishing features; and outputting a near-field signal and a far-field signal according to the near-field beamforming signal, the far-field beamforming signal and the near-field voice probability of the microphone array signal. In the embodiment of the present application, a near-field voice and a far-field voice can be effectively separated through the microphone array signal, so that the wearer voice and the far-field voice are obtained.

### CROSS-REFERENCE TO RELATED APPLICATIONS

The present disclosure is a continuation application of International Application No. PCT/CN2025/082499, filed on Mar. 14, 2025, the contents of which are incorporated herein by reference in its entirety.

### TECHNICAL FIELD

The present application relates to the technical field of voice processing and, in particular, to a method for separating far-field and near-field voice, an apparatus and a wearable device.

### BACKGROUND

With the gradual popularity of wearable devices, such as a true wireless stereo (TWS) and augmented reality (AR) glasses, voice applications based on the wearable devices are also more and more extensive; in application scenarios, such as voice calls, voice assistants, and far-field translation, technologies for distinguishing between a speech of a wearer and a speech of another person are essential.

In terms of the voice call, the wearable device needs to be able to cancel sounds of a background speaker other than the wearer to provide a clear call experience; for the voice assistant function, the wearable device needs to be able to recognize a voice instruction of the wearer and provide a response; for the far-field translation scenario, the wearable device needs to be able to distinguish between sounds of the wearer and sounds of a far-field speaker, and thus be able to translate only the far-field voice.

A common solution in the prior art is to use a directional beamforming technology to pick up the far-field voice or near-field voice and input it to a relevant application based on multi-microphone audio signals picked up by a microphone array. However, although this solution can improve the signal-to-noise ratio of the near-field or far-field voice to some extent, it still cannot completely separate the near-field voice from the far-field voice.

Therefore, it is necessary to provide a far-field and near-field voice separation method, an apparatus and a wearable device.

### SUMMARY

An objective of embodiments of the present application is to provide a far-field and near-field voice separation method and apparatus and a wearable device.

The technical solution of the present application is as follows.

In a first aspect, an embodiment of the present application provides a far-field and near-field voice separation method, including:
obtaining a near-field beamforming signal and a far-field beamforming signal according to microphone array signal obtained in a target scenario and a beamforming algorithm;
calculating distinguishing features between the near-field beamforming signal and the far-field beamforming signal;
obtaining a near-field voice probability of the microphone array signal according to the distinguishing features; and
outputting a near-field signal and a far-field signal according to the near-field beamforming signal, the far-field beamforming signal and the near-field voice probability of the microphone array signal.

As an improvement, the step of obtaining a near-field voice probability of the microphone array signal according to the distinguishing features includes:
determining a near-field voice probability of each distinguishing feature according to relationships between each distinguishing feature and a first threshold and a second threshold; and
calculating the near-field voice probability of the microphone array signal according to the near-field voice probabilities of the distinguishing features.

As an improvement, for the determining a near-field voice probability of each distinguishing feature according to relationships between each distinguishing feature and a first threshold and a second threshold, a calculation formula is as follows:

$${P}_{j} = \{ \begin{matrix}0 , & {D}_{j} < {thL}_{j} \\ ( {D}_{j} - {thL}_{j} ) / ( {thH}_{j} - {thL}_{j} ) , & {thL}_{j} \leq {D}_{j} \leq {thH}_{j} \\ 1 , & {D}_{j} > {thH}_{j}\end{matrix} ;$$

wherein Pⱼ represents the near-field voice probability of the jth distinguishing feature, Dⱼ represents the j th distinguishing feature, thHⱼ represents the first threshold corresponding to the j th distinguishing feature, thLⱼ represents the second threshold corresponding to the jth distinguishing feature, and j is a positive integer.

As an improvement, for the outputting a near-field signal and a far-field signal according to the near-field beamforming signal, the far-field beamforming signal and the near-field voice probability of the microphone array signal, calculation formulas are as follows:

$${S}_{near , f 1}^{′} = {S}_{n e a r , f 1} * P ;$$

$${S}_{far , f 1}^{′} = {S}_{far , f 1} * ( 1 - P ) ;$$

where f1 represents a sampling frequency band, S′_{near,f1} represents the near-field signal corresponding to the sampling frequency band, S′_{far,f1} represents the far-field signal corresponding to the sampling frequency band, S_{near,f1} represents the near-field beamforming signal corresponding to the sampling frequency band, S_{far,f1} represents the far-field beamforming signal corresponding to the sampling frequency band, and P represents the near-field voice probability of the microphone array signal.

As an improvement, the step of calculating distinguishing features between the near-field beamforming signal and the far-field beamforming signal includes:
calculating an energy difference signal between the near-field beamforming signal and the far-field beamforming signal at each sampling frequency point; and
obtaining the distinguishing feature of each sampling frequency point according to the near-field beamforming signal, the far-field beamforming signal and the energy difference signal.

As an improvement, the step of obtaining a near-field voice probability of the microphone array signal according to the distinguishing features includes:

splicing the distinguishing features of the sampling frequency points, and then inputting the result into a neural network to obtain the near-field voice probability of the microphone array signal.

As an improvement, for the outputting a near-field signal and a far-field signal according to the near-field beamforming signal, the far-field beamforming signal and the near-field voice probability of the microphone array signal, calculation formulas are as follows:

$${S}_{near , f}^{′} = {S}_{n e a r , f} * {q}_{f} ;$$

$${S}_{f a r , f}^{′} = {S}_{far , f} * ( 1 - {q}_{f} ) ;$$

where S′_{near,f} represents the near-field signal corresponding to the f-th sampling frequency point, S′_{far,f} represents the far-field signal corresponding to the f-th sampling frequency point, S_{near,f} represents the near-field beamforming signal corresponding to the f-th sampling frequency point, S_{far,f} represents the far-field beamforming signal corresponding to the f-th sampling frequency point, and q_{f} represents the near-field voice probability corresponding to the f-th sampling frequency point.

As an improvement, the microphone array signal are obtained by microphones in a small triangle layout, and for the obtaining a near-field beamforming signal and a far-field beamforming signal according to microphone array signal obtained in a target scenario and a beamforming algorithm, calculation formulas are as follows:

$${S}_{near , f} = {\sum }_{i = 1}^{3} {w}_{near , i , f} * {M}_{i , f} ;$$

$${S}_{far , f} = {\sum }_{i = 1}^{3} {w}_{far , i , f} * {M}_{i , f} ;$$

where f represents the sampling frequency point, S_{near,f} represents the near-field beamforming signal corresponding to the f-th sampling frequency point, S_{far,f} represents the far-field beamforming signal corresponding to the f-th sampling frequency point, i represents the i-th microphone array signal, w_{near,i,f} represents a first filter weight corresponding to the f-th sampling frequency point of the i-th microphone array signal, w_{far,i,f} represents a second filter weight corresponding to the f-th sampling frequency point of the i-th microphone array signal, and M_{i,f} represents a frequency domain signal of a time domain signal corresponding to the i-th microphone array signal at the f-th sampling frequency point after STFT.

In a second aspect, an embodiment of the present application provides a far-field and near-field voice separation apparatus, including:

a acquisition module configured to obtain a near-field beamforming signal and a far-field beamforming signal according to microphone array signal obtained in a target scenario and a beamforming algorithm;

a feature module configured to calculate distinguishing features between the near-field beamforming signal and the far-field beamforming signal;

a probability module configured to obtain a near-field voice probability of the microphone array signal according to the distinguishing features; and

a separating module configured to output a near-field signal and a far-field signal according to the near-field beamforming signal, the far-field beamforming signal and the near-field voice probability of the microphone array signal.

In a third aspect, an embodiment of the present application provides a wearable device, including the far-field and near-field voice separation apparatus provided in the second aspect.

The present application has the following beneficial effects: the microphone array signal obtained in the target scenario are obtained, and the near-field beamforming signal and the far-field beamforming signal are obtained by using the beamforming algorithm; the distinguishing features between the near-field beamforming signal and the far-field beamforming signal are calculated, and the near-field voice probability of the microphone array signal is calculated according to the distinguishing features; and finally, a near-field voice and a far-field voice are output based on the near-field voice probability. In the embodiment of the present application, the near-field voice and the far-field voice can be effectively separated through the microphone array signal, so that the wearer voice and the far-field voice are obtained.

### BRIEF DESCRIPTION OF DRAWINGS

FIG. 1 is a schematic diagram of an application scenario of a far-field and near-field voice separation method according to an embodiment of the present application;

FIG. 2 is a flow chart of a far-field and near-field voice separation method according to an embodiment of the present application;

FIG. 3 is a schematic structural diagram of a far-field and near-field voice separation apparatus according to an embodiment of the present application; and

FIG. 4 is a schematic structural diagram of a wearable device according to an embodiment of the present application.

### DESCRIPTION OF EMBODIMENTS

The present application is further described below with reference to the drawings and the embodiments.

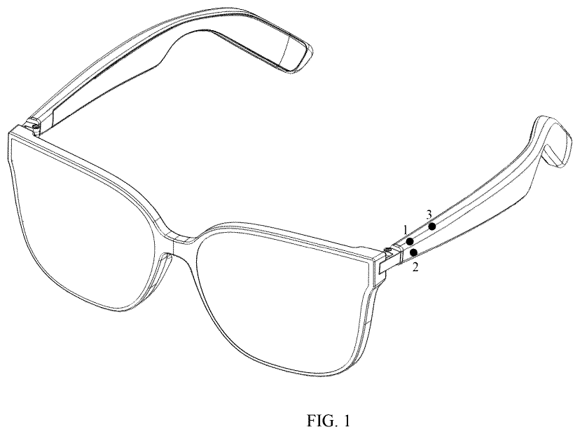

FIG. 1 is a schematic diagram of an application scenario of a far-field and near-field voice separation method according to an embodiment of the present application, and as shown in FIG. 1, the method may be applied to wearable devices, such as a TWS and AR glasses, the description is given with the AR glasses as an example, and generally, the AR glasses include a plurality of microphones, and a wearer wears the AR glasses. After receiving a separation instruction, a controller in the AR glasses obtains a near-field beamforming signal and a far-field beamforming signal according to microphone array signal obtained in a target scenario and a beamforming algorithm; calculates distinguishing features between the near-field beamforming signal and the far-field beamforming signal; obtains a near-field voice probability of the microphone array signal according to the distinguishing features; and outputs a near-field signal and a far-field signal according to the near-field beamforming signal, the far-field beamforming signal and the near-field voice probability. Thus, the AR glasses can well separate a near-field voice and a far-field voice to eliminate the far-field voice outside the wearer, provides the wearer with a clear call experience, and improves the use experience of the wearer for the AR glasses.

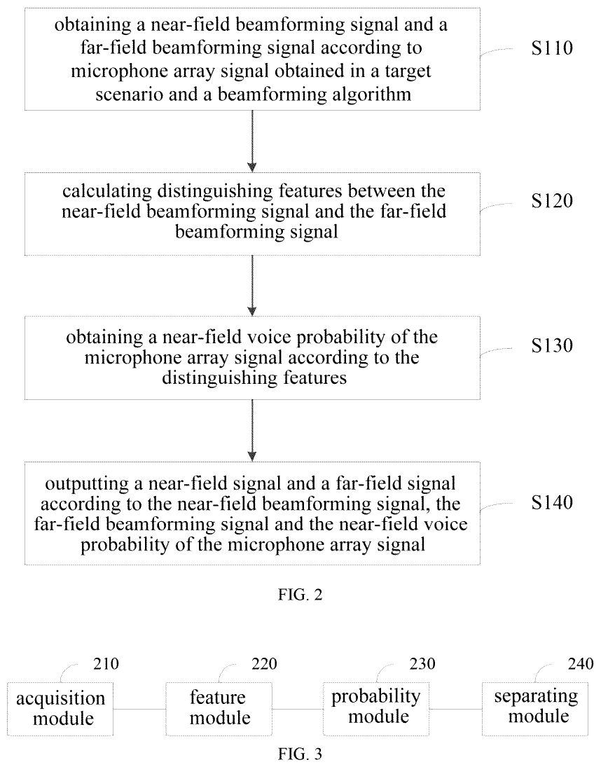

FIG. 2 is a flow chart of a far-field and near-field voice separation method according to an embodiment of the present application, and as shown in FIG. 2, the method includes the following steps.

The far-field and near-field voice separation method according to the embodiment of the present application is explained with an application to AR glasses as an example, the AR glasses include 3 microphones, the microphones are all traditional microphones, three of the microphones are located on one temple of the AR glasses, and the three microphones form a small triangle layout, as shown in FIG. 1, in which the reference numerals 1 to 3 all represent the traditional microphones.

A target scenario can be a scenario that a wearer wearing the AR glasses talks with another person, and in this target scenario, a sound of the wearer is a near-field voice, a sound of the other person is a far-field voice, and by performing this far-field and near-field voice separation method, the sounds of the wearer and the other person can be effectively separated to improve the use experience of the wear for the AR glasses.

S110: obtaining a near-field beamforming signal and a far-field beamforming signal according to microphone array signal obtained in a target scenario and a beamforming algorithm.

The microphone array signal obtained by the microphones in the target scenario are obtained, and the microphone array signal include audio signals obtained by the three microphones and containing speaking audios of the wearer and speaking audios of the other people nearby. After the microphone array signal are obtained, the near-field beamforming signal and the far-field beamforming signal can be obtained through the beamforming algorithm.

The beamforming algorithm is a signal processing technology, and the beamforming algorithm has a core concept that weighted summation is performed on the microphone array signal received by the microphones in the AR glasses, so as to form a beam with a specific directivity, which can enhance the signal strength in a desired direction while suppressing interference signals in other directions.

Exemplarily, when the near-field beamforming signal and the far-field beamforming signal are obtained with the beamforming algorithm, firstly, a signal model is required to be established to distinguish a near field from a far field; then, guide vectors are constructed to obtain a near-field guide vector and a far-field guide vector; and based on the near-field guide vector and the far-field guide vector, covariance matrix estimation is performed, and finally, separation is performed based on a minimum variance distortionless response algorithm or a subspace method, thereby obtaining the near-field beamforming signal and the far-field beamforming signal.

S120: calculating distinguishing features between the near-field beamforming signal and the far-field beamforming signal.

After the near-field beamforming signal and the far-field beamforming signal are obtained in the above step, the distinguishing feature at the frame level is calculated according to phonetic characteristics of the wearer and the nearby non-wearer. The distinguishing feature may be any feature capable of distinguishing between the near-field beamforming signal and the far-field beamforming signal, such as a far-field and near-field energy difference and a far-field and near-field signal correlation.

The distinguishing feature can be the far-field and near-field energy difference. Since the distance between the microphone and the mouth is short, voice energy of the wearer is often larger than that of the non-wearer, and after the processing based on the beamforming algorithm, the far-field and near-field energy difference is further amplified, so that the far-field and near-field energy difference between the near-field beamforming signal and the far-field beamforming signal can be effectively used for judging the far-field voice and the near-field voice.

The distinguishing feature can be the far-field and near-field signal correlation. When the wearer speaks, due to the large voice energy of the wearer, after the processing through the beamforming algorithm, besides near-field output, a far-field beam output signal contains a certain quantity of wearer voices, and at this point, the far-field and near-field signal correlation is large; when the non-wearer speaks, a near-field output signal contains fewer non-wearer voices, and the far-field output signal contains the non-wearer voices, and at this point, the far-field and near-field signal correlation is small. The wearer voice and the non-wearer voice can be distinguished based on the far-field and near-field signal correlation.

It should be noted that the above distinguishing feature may be calculated based on the full frequency band of the microphone array signal, or may be calculated based on a certain fixed frequency band (e.g., 300 Hz to 4,000 Hz) selected according to the frequency range of the microphone array signal and the discrimination degree of the feature, so as to reduce algorithm complexity.

S130: obtaining a near-field voice probability of the microphone array signal according to the distinguishing features.

After the distinguishing feature is calculated, the near-field voice probability of the microphone array signal is determined according to the distinguishing feature. For example, a fixed threshold may be set based on the distinguishing feature, and when the distinguishing feature is greater than the threshold, the near-field voice probability is determined to be P, otherwise, the near-field voice probability is determined to be 1-P.

It should be noted that, in the embodiment of the present application, the AR glasses include 3 microphones, and therefore, each microphone collects one microphone array signal, and the microphone array signal are processed by the beamforming algorithm to obtain the corresponding near-field beamforming signal and far-field beamforming signal, so that each microphone array signal corresponds to one distinguishing feature.

According to each distinguishing feature, near-field voice probabilities corresponding to the microphone array signal can be multiplied to determine the near-field voice probability of all the microphone array signal, and the near-field voice probability of the microphone array signal is a near-field voice probability of a voice audio obtained by the AR glasses.

S140: outputting a near-field signal and a far-field signal according to the near-field beamforming signal, the far-field beamforming signal and the near-field voice probability.

In the embodiment of the present application, according to the near-field beamforming signal and the near-field voice probability, further refining is performed to remove noise in the near-field beamforming signal to obtain the near-field signal; and according to the far-field beamforming signal and the near-field voice probability, further refining is performed to remove noise in the far-field beamforming signal to obtain the far-field signal.

The embodiment of the present application provides the far-field and near-field voice separation method, the microphone array signal obtained in the target scenario are first obtained, and the near-field beamforming signal and the far-field beamforming signal are obtained by using the beamforming algorithm; the distinguishing features between the near-field beamforming signal and the far-field beamforming signal are calculated, and the near-field voice probability of the microphone array signal is calculated according to the distinguishing features; and finally, a near-field voice and a far-field voice are output based on the near-field voice probability. In the embodiment of the present application, the near-field voice and the far-field voice can be effectively separated through the microphone array signal, so that the wearer voice and the far-field voice are obtained.

As an embodiment, the step of obtaining a near-field voice probability of the microphone array signal according to the distinguishing features includes:
determining a near-field voice probability of each distinguishing feature according to relationships between each distinguishing feature and a first threshold and a second threshold; and
calculating the near-field voice probability of the microphone array signal according to the near-field voice probabilities of the distinguishing features.

In the embodiment of the present application, when the distinguishing feature is the far-field and near-field signal correlation, the first threshold and the second threshold are set for each distinguishing feature, and the first/second thresholds corresponding to different distinguishing features may be the same or different, and may be determined according to actual situations, which is not specifically limited in the embodiment of the present application.

The near-field voice probability of each distinguishing feature is determined according to the relationships between each distinguishing feature and the first threshold and the second threshold, and the near-field voice probabilities of the distinguishing features are multiplied to obtain the near-field voice probability of the voice audio obtained by the AR glasses.

As an example, for the determining a near-field voice probability of each distinguishing feature according to relationships between each distinguishing feature and a first threshold and a second threshold, a calculation formula is as follows:

$${P}_{j} = \{ \begin{matrix}0 , & {D}_{j} < {thL}_{j} \\ ( {D}_{j} - {thL}_{j} ) / ( {thH}_{j} - {thL}_{j} ) , & {thL}_{j} \leq {D}_{j} \leq {thH}_{j} \\ 1 , & {D}_{j} > {thH}_{j}\end{matrix} ;$$

where Pⱼ represents the near-field voice probability of the jth distinguishing feature, D; represents the jth distinguishing feature, thHⱼ represents the first threshold corresponding to the jth distinguishing feature, thLⱼ represents the second threshold corresponding to the jth distinguishing feature, and j is 1, 2 or 3.

As an example, for the outputting a near-field signal and a far-field signal according to the near-field beamforming signal, the far-field beamforming signal and the near-field voice probability of the microphone array signal, calculation formulas are as follows:

$${S}_{near , f 1}^{′} = {S}_{n e a r , f 1} * P ;$$

$${S}_{far , f 1}^{′} = {S}_{far , f 1} * ( 1 - P ) ;$$

where f1 represents a sampling frequency band, S′_{near,f1} represents the near-field signal corresponding to the sampling frequency band, S′_{far,f1} represents the far-field signal corresponding to the sampling frequency band, S_{near,f1} represents the near-field beamforming signal corresponding to the sampling frequency band, S_{far,f1} represents the far-field beamforming signal corresponding to the sampling frequency band, and P represents the near-field voice probability of the microphone array signal.

It should be noted that f1 may be the entire frequency band of the microphone array signal, or may be a fixed frequency band therein, which may be determined according to actual conditions, and is not specifically limited in the embodiment of the present application.

In some embodiments, the step of calculating distinguishing features between the near-field beamforming signal and the far-field beamforming signal includes:
calculating an energy difference signal between the near-field beamforming signal and the far-field beamforming signal at each sampling frequency point; and
obtaining the distinguishing feature of each sampling frequency point according to the near-field beamforming signal, the far-field beamforming signal and the energy difference signal.

In the embodiment of the present application, when the distinguishing feature is the energy difference signal, a plurality of sampling frequency points are set, and the energy difference signal of the near-field beamforming signal and the far-field beamforming signal at each sampling frequency point is calculated; and the near-field beamforming signal, the far-field beamforming signal and the energy difference signal at each sampling frequency point are taken as the distinguishing features at each sampling frequency point.

As an embodiment, the step of obtaining a near-field voice probability of the microphone array signal according to the distinguishing features includes:
splicing the distinguishing features of the sampling frequency points, and then inputting the result into a neural network to obtain the near-field voice probability of the microphone array signal.

After the distinguishing features of each sampling frequency point are calculated, the distinguishing features of each sampling frequency point are spliced together again and then input into the neural network, so that the near-field voice probability of the voice audio obtained by the whole AR glasses is obtained.

Exemplarily, the distinguishing feature of the f-th sampling frequency point may be represented as (S_{near,f})−(S_{far,f})′, the near-field beamforming signal of the f-th sampling frequency point may be represented as S_{near,f}, the far-field beamforming signal of the f-th sampling frequency point may be represented as S_{far,f}, the distinguishing features of all the sampling frequency points are spliced together as an input feature vector of the neural network, and a wearer voice probability after the neural network may be represented as:

$$Q = N e t ( K ) ;$$

where Q=[q₁, . . . , q_{f}, . . . , q_{F}], f represents the f-th sampling frequency point, F is the total number of the sampling frequency points, and K is the input feature vector, namely the vector obtained by splicing the distinguishing features of all the sampling frequency points together.

As an embodiment, for the outputting a near-field signal and a far-field signal according to the near-field beamforming signal, the far-field beamforming signal and the near-field voice probability of the microphone array signal, calculation formulas are as follows:

$${S}_{near , f}^{′} = {S}_{n e a r , f} * {q}_{f} ;$$

$${S}_{f a r , f}^{′} = {S}_{f a r , f} * ( 1 - {q}_{f} ) ;$$

where S′_{near,f} represents the near-field signal corresponding to the f-th sampling frequency point, S′_{far,f} represents the far-field signal corresponding to the f-th sampling frequency point, S_{near,f} represents the near-field beamforming signal corresponding to the f-th sampling frequency point, S_{far,f} represents the far-field beamforming signal corresponding to the f-th sampling frequency point, and q_{f} represents the near-field voice probability corresponding to the f-th sampling frequency point.

As an embodiment, the microphone array signal are obtained by microphones in a small triangle layout, and for the obtaining a near-field beamforming signal and a far-field beamforming signal according to microphone array signal obtained in a target scenario and a beamforming algorithm, calculation formulas are as follows:

$${S}_{near , f} = {\sum }_{i = 1}^{3} {w}_{near , i , f} * {M}_{i , f} ;$$

$${S}_{far , f} = {\sum }_{i = 1}^{3} {w}_{far , i , f} * {M}_{i , f} ;$$

where f represents the sampling frequency point, S_{near,f} represents the near-field beamforming signal corresponding to the f-th sampling frequency point, S_{far,f} represents the far-field beamforming signal corresponding to the f-th sampling frequency point, i represents the i-th microphone array signal, w_{near,i,f} represents a first filter weight corresponding to the f-th sampling frequency point of the i-th microphone array signal, w_{far,i,f} represents a second filter weight corresponding to the f-th sampling frequency point of the i-th microphone array signal, and M_{i,f} represents a frequency domain signal of a time domain signal corresponding to the i-th microphone array signal at the f-th sampling frequency point after STFT.

FIG. 3 is a schematic structural diagram of a far-field and near-field voice separation apparatus according to an embodiment of the present application, and as shown in FIG. 3, the apparatus includes:
an acquisition module 210 configured to obtain a near-field beamforming signal and a far-field beamforming signal according to microphone array signal obtained in a target scenario and a beamforming algorithm;
a feature module 220 configured to calculate distinguishing features between the near-field beamforming signal and the far-field beamforming signal;
a probability module 230 configured to obtain a near-field voice probability of the microphone array signal according to the distinguishing features; and
a separating module 240 configured to output a near-field signal and a far-field signal according to the near-field beamforming signal, the far-field beamforming signal and the near-field voice probability of the microphone array signal.

The present embodiment is an apparatus embodiment corresponding to the above method, the implementation process thereof is the same as that of the method embodiment, and reference may be made to the above method embodiment for details which are not repeated herein.

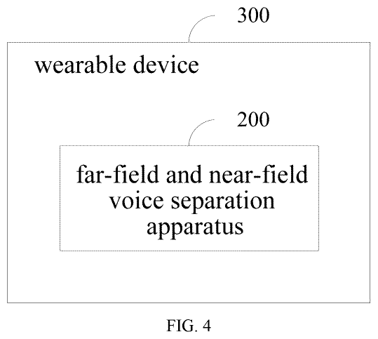

FIG. 4 is a schematic structural diagram of a wearable device according to an embodiment of the present application, and as shown in FIG. 4, the wearable device 300 includes the above far-field and near-field voice separation apparatus 200. The wearable device includes a TWS, AR glasses, or the like.

The above description is only embodiments of the present application, and it should be noted that improvements can be made by those of ordinary skill in the art without departing from the concept of the present application, and all fall within the protection scope of the present application.

What is claimed is:

1. A method for separating a far-field and near-field voice, comprising:
obtaining a near-field beamforming signal and a far-field beamforming signal according to a microphone array signal obtained in a target scenario and a beamforming algorithm;
calculating distinguishing features between the near-field beamforming signal and the far-field beamforming signal;
obtaining a near-field voice probability of the microphone array signal according to the distinguishing features; and
outputting a near-field signal and a far-field signal according to the near-field beamforming signal, the far-field beamforming signal and the near-field voice probability of the microphone array signal.

2. The method as described in claim 1, wherein the obtaining the near-field voice probability of the microphone array signal according to the distinguishing features comprises:
determining a near-field voice probability of each distinguishing feature of the distinguishing features according to relationship between each distinguishing feature and a first threshold and relationship between each distinguishing feature and a second threshold; and
calculating the near-field voice probability of the microphone array signal according to the near-field voice probability of the each distinguishing feature.

3. The method as described in claim 2, wherein for the determining the near-field voice probability of each distinguishing feature of the distinguishing features according to relationships among the each distinguishing feature, a first threshold and a second threshold, a calculation formula is as follows:
$${P}_{j} = \{ \begin{matrix}0 , & {D}_{j} < {thL}_{j} \\ ( {D}_{j} - {thL}_{j} ) / ( {thH}_{j} - {thL}_{j} ) , & {thL}_{j} \leq {D}_{j} \leq {thH}_{j} \\ 1 , & {D}_{j} > {thH}_{j}\end{matrix} ;$$
wherein Pⱼ represents a near-field voice probability of a jth distinguishing feature, Dⱼ represents the jth distinguishing feature, thHⱼ represents a first threshold corresponding to the j th distinguishing feature, thLⱼ represents a second threshold corresponding to the j th distinguishing feature, and j is a positive integer.

4. The method as described in claim 2, wherein for the outputting the near-field signal and the far-field signal according to the near-field beamforming signal, the far-field beamforming signal and the near-field voice probability of the microphone array signal, calculation formulas are as follows:
$${S}_{near , f 1}^{′} = {S}_{n e a r , f 1} * P ;$$
$${S}_{far , f 1}^{′} = {S}_{far , f 1} * ( 1 - P ) ;$$
wherein f1 represents a sampling frequency band, S′_{near,f1} represents the near-field signal corresponding to the sampling frequency band, S′_{far,f1} represents the far-field signal corresponding to the sampling frequency band, S_{near,f1} represents the near-field beamforming signal corresponding to the sampling frequency band, S_{far,f1} represents the far-field beamforming signal corresponding to the sampling frequency band, and P represents the near-field voice probability of the microphone array signal.

5. The method as described in claim 1, wherein the calculating distinguishing features between the near-field beamforming signal and the far-field beamforming signal comprises:
calculating an energy difference signal between the near-field beamforming signal and the far-field beamforming signal at each sampling frequency point; and
obtaining the distinguishing feature of each sampling frequency point according to the near-field beamforming signal, the far-field beamforming signal and the energy difference signal.

6. The method as described in claim 5, wherein the obtaining the near-field voice probability of the microphone array signal according to the distinguishing features comprises:
splicing the distinguishing feature of the each sampling frequency point and inputting into a neural network to obtain the near-field voice probability of the microphone array signal.

7. The method as described in claim 6, wherein for the outputting the near-field signal and the far-field signal according to the near-field beamforming signal, the far-field beamforming signal and the near-field voice probability of the microphone array signal, calculation formulas are as follows:
$${S}_{near , f}^{′} = {S}_{near , f} * {q}_{f} ;$$
$${S}_{far , f}^{′} = {S}_{far , f} * ( 1 - {q}_{f} ) ;$$
wherein S′_{near,f} represents a near-field signal corresponding to a f-th sampling frequency point, S′_{far,f} represents a far-field signal corresponding to the f-th sampling frequency point, S_{near,f} represents a near-field beamforming signal corresponding to the f-th sampling frequency point, S_{far,f} represents a far-field beamforming signal corresponding to the f-th sampling frequency point, and q_{f} represents a near-field voice probability corresponding to the f-th sampling frequency point.

8. The method as described in claim 1, wherein the microphone array signal is obtained by microphones in a small triangle layout, and for the obtaining the near-field beamforming signal and the far-field beamforming signal according to the microphone array signal obtained in the target scenario and the beamforming algorithm, calculation formulas are as follows:
$${S}_{n e a r , f} = {\sum }_{i = 1}^{3} {w}_{near , i , f} * {M}_{i , f} ;$$
$${S}_{far , f} = {\sum }_{i = 1}^{3} {w}_{far , i , f} * {M}_{i , f} ;$$
wherein f represents a sampling frequency point, S_{near,f} represents a near-field beamforming signal corresponding to a f-th sampling frequency point, S_{far,f} represents a far-field beamforming signal corresponding to the f-th sampling frequency point, i represents an i-th microphone array signal, w_{near,i,f} represents a first filter weight corresponding to the f-th sampling frequency point of the i-th microphone array signal, w_{far,i,f} represents a second filter weight corresponding to the f-th sampling frequency point of the i-th microphone array signal, and M_{i,f} represents a frequency domain signal of a time domain signal corresponding to the i-th microphone array signal at the f-th sampling frequency point after short-time Fourier transform (STFT).

9. An apparatus for separating a far-field and near-field voice, comprising:
an acquisition module configured to obtain a near-field beamforming signal and a far-field beamforming signal according to microphone array signal obtained in a target scenario and a beamforming algorithm;
a feature module configured to calculate a distinguishing feature between the near-field beamforming signal and the far-field beamforming signal;
a probability module configured to obtain a near-field voice probability of the microphone array signal according to the distinguishing feature; and
a separating module configured to output a near-field signal and a far-field signal according to the near-field beamforming signal, the far-field beamforming signal and the near-field voice probability of the microphone array signal.

10. A wearable device, comprising the apparatus according to claim 9.
